(19) United States
(12) Patent Application Publication
(10) Pub. No.: US 2003/0110051 A1
(43) Pub. Date: Jun. 12, 2003

(54) System and method for selecting an article of manufacture

(76) Inventor: Thomas E. Altman, Middletown, NY (US)

Correspondence Address: Richard C. Stewart, II, International Paper Company, 1422 Long Meadow Road, Tuxedo, NY, 10987, US

(21) Appl. No.: 10/021,103

(22) Filed: Dec. 7, 2001

(51) Int. Cl. G06F 17/60

(52) U.S. Cl. 705/1

(57) ABSTRACT

Disclosed are systems and methods enabling a purchaser to select for purchase an article of manufacture from a plurality of like articles of manufacture over a computer network. The plurality of like articles of manufacture have properties whose actual values vary due to a manufacturing process. A method includes acquiring actual values for properties of the article of manufacture and storing the actual values as a database. The actual values are transmitted to a processor that is programmed to compare each desired value of a property selected by a purchaser with the actual value for each respective property of the article of manufacture to determine whether there is a match between each desired value and the actual value for each respective property. The purchaser may select and transmit an offer to purchase the article of manufacture.

### BACKGROUND OF THE INVENTION

1. Field of the Invention

The present invention relates generally to systems and methods that enable a purchaser to specify desired values for properties of an article of manufacture and, more particularly, to systems and methods that enable a purchaser to specify desired values for one or more properties of a grade of paper and search a database for actual values for each respective property of a manufacture of the grade of paper to determine whether there is a match between each desired value and the actual value for each respective property.

2. Background of the Related Art

Paper products are available in many different grades. For convenience, the grades may be grouped into several broad classifications including sanitary papers; glassine, greaseproof, and waxing papers; food-board; box-board; printing papers; liner-board and bag paper; and corrugating medium. Each classification includes a number of grades. Within the classification of printing papers, for example, there are the grades bond, coated, text, book, offset, cover, index, tag, bristol, newsprint, lightweight, and writing paper. The name of a paper product's grade and the classification in which it is grouped are descriptive of its use. However, such descriptive information is insufficient in assisting a purchaser to determine whether a paper product will satisfy his requirements. More detailed information is required.

A paper product may be more particularly described by its properties. Four main categories of paper properties are optical properties (e.g., brightness and opacity), internal strength properties (e.g., paper burst and tensile strength), surface properties (e.g., abrasion resistance and water absorptivity), and composition properties (e.g., basis weight and caliper.) A comprehensive list of paper properties and the specifications for measuring the same is found at www.integratedpaperservice.com, a web site supported by Integrated Paper Services, Inc., of Appleton, Wis.

Importantly, it is the prominent properties of paper products that distinguish one grade of paper from another. In other words, although all grades of paper have measurable (however negligible) optical, internal strength, surface, and composition properties, each grade of paper has a particular set of properties that are more pronounced and thereby distinguish it from paper products of other grades. For example, offset paper has high surface smoothness, ink absorptivity, moisture resistivity, and picking resistivity, while cover paper has high durability, uniform printability, fold endurance, and good scoring, embossing, and die-cutting properties.

As one would expect, each grade of paper includes basically the same fiber, color, additive and chemical composition. During processing, this composition is blended to form a “furnish” that is fed into the “wet end” of a papermaking machine. Ultimately, however, the properties of each grade of paper are determined by a combination of the composition of the furnish, the papermaking machine, and finishing operations.

It would appear that paper products identified by manufacturers as the same grade would have the same or nearly the same prominent properties (i.e., substantially the same property values.) However, because of the numerous composition and process variables, paper products within each grade are notoriously inconsistent. The inconsistencies are caused in large part by the differences between the compositions of furnish, papermaking machines, operating conditions, and processing techniques used by each manufacturer to make their paper products.

Worse yet, there are often inconsistencies between the same grade of paper manufactured on the same papermaking machine and, furthermore, between one portion of a manufacture grade of paper (i.e., a continuous sheet of a grade of paper) and another portion of the same manufacture. For example, paper products cut from edge rolls are known to be less desirable than paper products cut from interior rolls because of uneven caliper and variations in tensile strength near the edge of the roll.

The variations between properties of each paper grade are particularly noticeable to buyers (e.g., paper purchasing agents) in the paper converting industry. This is because property variations can severely impact the performance of converting machines. The present disclosure defines a “converting machine” as any machine that processes a paper product including, but not limited to, printing presses, envelope-folding machines, corrugating machines, die-cutting machines.

To get around the problems associated with property variations, buyers routinely select grades of paper that they have successfully run on their converting machines. For the reasons noted above, however, even if a buyer purchases the same grade of paper from the same paper manufacturer, there is no guarantee that the properties of the paper will be consistent.

Of course, any interruption in the operation of a converting machine will result in an economic loss for the converting machine operator and the paper supplier: the operator losing setup costs and credibility with his client; the paper supplier bearing the expense to replace the “deficient” paper product. For example, if a paper product will not properly feed through the converting machine because the surface finish is too smooth (e.g., out of tolerance for the particular grade) and, therefore the machines grippers cannot properly grip the sheets, then the buyer has little recourse but to discontinue the converting operation and return the paper product to the paper supplier.

For this reason, purchasing paper products to satisfy the requirements for a particular paper converting machine is a tedious, time consuming, and expensive endeavor. Buyers must have a sophisticated understanding of the converting machine for which the paper is to be purchased, be familiar with the numerous grades of paper products available in the market, recognize that identical paper grades can have property variations, and have an appreciation of the economics of purchasing paper products. All to often, notwithstanding the efforts of the buyer, a purchased paper product is unsatisfactory because one or more of the property values are not suitable for the particular converting machine on which the paper is to be used.

It would be advantageous if buyers could select a paper product having properties that more particularly met their needs. As described above, the present way in which buyers purchase paper does not allow them to specify select property values.

Systems and methods have been developed in an attempt to ascertain property values of products, however, they have disadvantages making them impractical for the problems discussed above. As an example, U.S. Pat. No. 5,864,483 to Brichta discloses a method for monitoring the manufacturing of products. The method includes the steps of receiving criteria information specifying an unacceptable level for products, where the unacceptable level is associated with one boundary of a stable region for a characteristic of the products. Thereafter, defining a danger zone distant from a statistical mean for the characteristic of the products and contained within the stable region proximate the boundary associated with the unacceptable level. Then receiving information relating to actual products and identifying non-random patterns in the defined danger zone in order to determine when the actual products are in danger of exceeding the unacceptable level.

A disadvantage of the invention disclosed by Brichta is it concerns monitoring products during the manufacturing process to determine when selected criteria of products are approaching unacceptable levels. Such monitoring may be useful to a manufacturer, however, it provides little assistance to a buyer that is seeking previously manufactured products with specific properties. That is, unless there is an arrangement between the manufacturer and the buyer, the manufacturer would not be aware of the particular criteria that are of interest to the buyer. Those skilled in the art will appreciate that such arrangements are impractical in the paper industry.

Accordingly, there presently are no systems or methods available that enable a buyer to search for a grade of paper having particular properties that will suit the buyer's requirements.

### SUMMARY OF THE DISCLOSURE

One aspect of the present invention is directed to a method for selecting an article of manufacture from a plurality of like articles of manufacture over a computer network, the plurality of like articles of manufacture having properties whose actual values are varied due to manufacturing processes. The method includes entering desired values for one or more of the properties of the article of manufacture. The desired values are transmitted to a processor programmed to compare each desired value with the actual value for each respective property of the article of manufacture to determine whether there is a match between each desired value and the actual value for each respective property. After processing, data are received from the processor indicating that each desired value is matched by the actual value for each respective property of the article of manufacture.

The step of entering desired values for the one or more of the properties of the article of manufacture may include entering desired values for the one or more of the properties of a particular grade of paper, wherein the properties are selected from the group comprising caliper, tensile strength, burst strength, tear resistance, abrasion resistance, picking resistance, fold endurance, ink/water absorptivity, brightness, opacity, finish, softwood/hardwood content, pH.

The method may further include entering a description of a converting machine on which the article of manufacture is intended for use. Thereafter, receiving default values, associated with the description of the converting machine, for one or more of the properties of the article of manufacture. The default values may be selected as the desired values for the one or more of the properties of the article of manufacture. The step of entering a description of a converting machine may include entering a description of a converting machine selected from the group comprising a printing press, an envelope-folding machine, a corrugating machine, a die-cutting machine.

The method may further include the steps of selecting the article of manufacture and transmitting an offer to purchase the selected article of manufacture to a product supplier. The step of transmitting an offer to purchase the selected article of manufacture may include the step of transmitting a bid or the step of transmitting an order to purchase the selected article of manufacture.

The step of receiving data from the processor may include receiving data indicating that each desired value is exactly matched by the actual value for each respective property of the article of manufacture or include receiving data indicating that the actual value for each respective property of the article of manufacture is within tolerances selected by the purchaser for each desired value.

Another aspect of the present invention is directed to a method for selecting an article of manufacture including the steps wherein a manufacturer acquires actual values for one or more of the properties of the article of manufacture and stores the actual values as part of a database. The actual values are transmitted to a processor programmed to compare each desired value of a property selected by a purchaser with the actual value for each respective property of the article of manufacture to determine whether there is a match between each desired value and the actual value for each respective property. The purchaser may transmit an offer to purchase the article of manufacture to a product supplier.

The step of transmitting the actual values to a processor may include the step of transmitting the actual values over the computer network to the purchaser for processing or transmitting the actual values over the computer network to a distributor for processing. The method may further include the step wherein the manufacturer processes the desired values and the actual values with the processor to determine whether there is a match between each desired value and the actual value for each respective property.

The method may further include the step of receiving offers from additional purchasers to purchase the article of manufacture, wherein the offer received from the purchaser and the offers received from the additional purchasers include bids for the article of manufacture. The method may also include the step of determining a winning bid based on predetermined auction criteria.

Another aspect of the present invention is directed to a computer system for selecting an article of manufacture from a plurality of like articles of manufacture over a computer network, the plurality of like articles of manufacture having properties whose actual values are varied due to manufacturing processes. The computer system includes a memory for storing actual values for properties of the article of manufacture and a processor in communication with the memory.

The processor is operative to receive the actual values for the properties of the article of manufacture; store the actual values as part of a database in the memory; receive a desired value from a purchaser for one or more properties of the article of manufacture; determine whether there is a match between each desired value and the actual value for each respective property of the article of manufacture by comparing each desired value with the actual value for each respective property; transmit data to the purchaser indicating that the desired values for the one or more properties are found in the article of manufacture; and receive an offer from the purchaser to purchase the article of manufacture. The actual values for the properties of the article of manufacture may be measured during or after the manufacturing processes.

Further features of the present invention will become more readily apparent from the following detailed description taken in conjunction with the drawings.

### BRIEF DESCRIPTION OF THE DRAWINGS

So that those of ordinary skill in the art to which the subject invention pertains will more readily understand how to make and use the systems and methods described herein, embodiments of the invention will be described in detail with reference to the drawings, wherein:

FIG. 1 is a flow chart illustrating a prior art paper manufacturing process;

FIG. 2 is a schematic representation of a network of computers used in an embodiment of the present invention;

FIG. 3 is a diagram illustrating a paper product specification screen;

FIG. 4 is a flow chart illustrating a method of the present invention; and

FIG. 5 is a flow chart illustrating a method of the present invention carried out by a manufacturer.

### DETAILED DESCRIPTION OF PREFERRED EMBODIMENTS

Reference is now made to the accompanying figures for the purpose of describing, in detail, embodiments of the present invention. The figures and accompanying detailed description are provided as examples of the invention and are not intended to limit the scope of the claims appended hereto.

The present invention provides a novel and unique system and method for a buyer to select and purchase paper products from a paper manufacturer. The invention generally includes a computer network interconnecting buyers, intermediaries, manufacturers, and distributors. The buyers and intermediaries, both alternatively referred to herein as purchasers, have access to measured values for properties of paper products manufactured by paper manufacturers. Purchasers may select a desired value for one or more properties of a particular paper product and have each desired value compared with the actual value for each respective property to determine whether there is a match between each desired value and the actual value for each respective property of a paper product. Purchasers receive information describing all products that are determined to be a match and may offer to purchase the products.

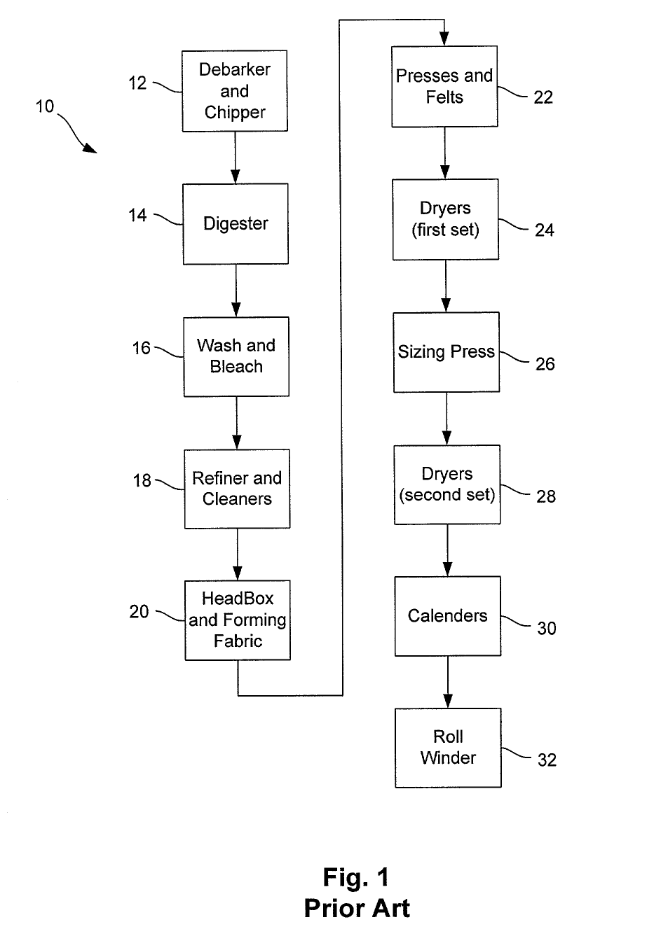

Referring to FIG. 1, a papermaking process is briefly described with reference to flow chart 10 to illustrate how properties are developed in paper products. Initially, at step 12, pulpwood logs are debarked and reduced to 2-inch square by 0.25-inch thick chips. Softwood and hardwood chips are kept separate until the pulp is blended at the paper machine. Because each type of wood imparts distinct properties into a paper product, the percentage of each is adjusted depending on the grade of paper that is being made.

At step 14, the cellulose fibers of the wood chips are separated by cooking them with chemicals in digesters to dissolve the lignin that binds them. The chips and chemicals are steamed under pressure for 1.5 to 4 hours until the mixture is reduced to a wet, oatmeal-like mass. The cooking process frees the fibers so they can be suspended in water.

At step 16, the pulp is blown from the digesters under pressure to separate the fibers. It is then washed to remove the cooking chemicals and dissolved lignin and then bleached to a proper shade of whiteness. At step 18, the pulp is passed through refiners that roughen the surface of the individual pulp fibers by loosening the threadlike elements from the fibers' walls so they will cling together when formed into a sheet. Dyes and other additives are added after refining to give the finished paper certain desired properties.

At step 20, to complete the furnish, water is added to the pulp in a ratio of about 200-parts water to one-part fiber (i.e., 1/2 (wt) %.) The furnish is fed to a headbox from which it is evenly spread onto a forming fabric or wire of the papermaking machine. The forming fabric is an endless mesh screen that circulates at the “wet end” of the paper machine and allows much of the water to drain away. The fibers become interlaced to form a mat of paper as the water is drained. The forming fabric travels at speeds of more than 3000 feet per minute (about 35 miles per hour.)

At step 22, the paper is pressed between water absorbing fabrics and, at step 24, wound through a series of steam-heated cylinders called dryers, where the last of the water in the sheet is removed. At step 26, the paper passes through a sizing press that applies a starch solution to both sides of the sheet. Sizing seals the surface of the sheet so ink cannot soak into the paper during printing. At step 28, since sizing wets the paper, the paper must be passed through a second dryer.

At step 30, the paper goes through a finishing process that provides a smooth surface finish by ironing the sheet between heavy, polished calender rollers. At step 32, at the “dry end” of the papermaking machine, the paper is wound onto a roll. The roll is later slit into narrower rolls. Some of these rolls are sent for sheeting and packing into cartons. Others are rewound to smaller-sized rolls.

Papermaking machines and processes are further described, for example, in “Handbook for Pulp & Paper Technologists,” 2nd ed., G. A. Smook, 1992, Angus Wilde Publications, Inc., and “Pulp and Paper Manufacture,” Vol. III (Papermaking and Paperboard Making), R. MacDonald, ed. 1970, McGraw Hill. Papermaking machines and processes are also described, for example, in U.S. Pat. Nos. 5,539,634; 5,022,966; 4,982,334; 4,786,817 and 4,767,935, the contents of which are incorporated by reference herein.

Sensors continually measure properties of a paper product as it is being formed on a papermaking machine. Such on-line measurements enable prompt control of papermaking processes and, thus, assure sheet quality while reducing the quantity of substandard sheet material that is produced before process upset conditions are corrected. The sensors are located at various positions along the length of the machine including, for example, in headbox feeders to detect the specific chemicals and additives that are mixed into the furnish; at various points along the length of the papermaking machine to detect the caliper of the sheet during its manufacture; and after the calender rollers to detect the finish of the sheet prior to being wound onto a roll. Properties may be controlled, for example, by adjusting the fiber, additive or chemical content of the furnish; adjusting the rate at which the furnish is fed onto the forming fabric or the velocity of the forming fabric; regulating the flow and pressure of steam applied to drying rollers; and varying the gap between calender rollers.

Paper manufacturers also take measurements of certain properties of a paper product after its manufacture. Typical post-manufacture measurements include tensile strength, burst strength, tear resistance, fold endurance, ink absorbency, and picking resistance. For the purpose of claiming the present invention, such measurements are considered as having been taken during the manufacturing processes.

When one considers that a papermaking machine can be several hundred feet long, and the multiple processes that a sheet must pass to be formed, it is understandable that an enormous amount of data is gathered during processing. Some of the data is used in feedback loops to adjust aspects of the manufacturing process. Once the data has been utilized, most of it is deleted, although, some of the data is stored to provide historical data for analyzing the condition of the papermaking machinery.

The present invention makes available certain types of the data obtained during paper manufacturing processes. By making such data available, a purchaser can select a grade of paper by considering the specific properties that are most important for the particular converting machine on which the paper will be used.

In order to make the best use of the processing data, it is desirable that an intermediary having knowledge of paper manufacturing processes, paper converting machines, and information technology is involved in the purchasing process. A paper buyer (e.g., a buyer at R. R. Donnelley and Sons Company) would then place orders for paper products with an intermediary who would utilize the data made available to him by paper manufacturers to determine which rolls of paper to purchase for his customer. The intermediary's core competencies would include information technology skills to transfer, filter and analyze large volumes of process data; papermaking process knowledge in order to recognize which process measurements are important for analysis; and a sound comprehension of buyers' converting machines and businesses.

Those skilled in the art can well appreciate that paper manufacturers may be reluctant to make their manufacturing data available to purchasers. However, it is anticipated that the advantages to both purchasers and manufacturers will justify and encourage their making such data available.

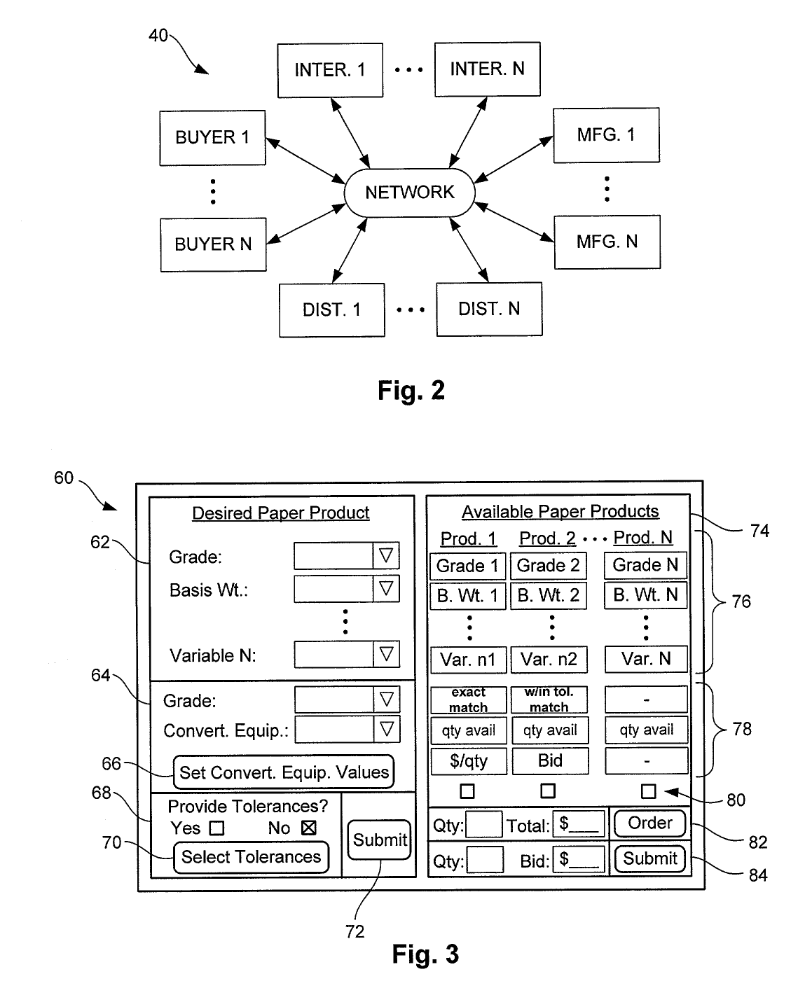

Referring to FIG. 2, a network of computers 40 is shown to illustrate a system of the present invention. The network of computers 40 includes a central network, for example, the Internet, over which buyers, intermediaries, manufacturers, and distributors may communicate.

In an exemplary transaction utilizing a system and method of the present invention BUYER-1 transmits an order for paper to INTER.-1 including a description of a paper grade and basis weight. In addition, BUYER-1 transmits a description of the converting machine on which the paper will be used. INTER.-1, armed with expert knowledge of the converting machine and the paper manufacturing processes of paper manufacturers MFG.-1 through MFG.-N, develops search criteria and searches databases of the paper manufacturers in search of a paper product ideally suited for BUYER-1's converting machine. The present system and method does not require a buyer to include an intermediary in the purchasing process, however, a skilled intermediary will likely be capable of getting the most suitable product at the best price. Buyers and intermediaries may both be described as purchasers.

Paper manufacturers will also be encouraged to include intermediaries in the purchasing process because the intermediaries will be capable of finding niche markets for paper products that manufacturers have until now considered difficult to sell due to one or more below-par variables. An example of a situation where an intermediary's knowledge facilitates the sale of below-par paper products follows.

An intermediary may know that a particular envelope-converting machine at one customer requires less stiffness than is typical. There may not be enough of these machines in the market for a paper manufacturer to set up its processing equipment to manufacturer a paper grade for this application. If the intermediary can sift through the process data and find some envelope paper that has lower stiffness than normal, possibly destined to be downgraded or re-pulped, and obtain it at a discount over the standard grade, this serves to customize the interaction for everyone. The paper manufacturer finds a custom use for the paper, with the market place setting the value based on the properties delivered. The purchaser who receives this paper will get a paper product that is fit for use at a lower price than the standard grade at the standard price.

Referring to FIG. 3, a diagram of a layout of a paper specification screen is shown at 60. The paper specification screen 60 may be used by a purchaser to search for a paper product having particular property values. In frame 62, a user may enter a description of a grade of paper and specific desired property values (e.g., basis weight, caliper, tensile strength) by either directly typing them in or by selecting values in a pull-down window.

Alternatively, in frame 64, a user may enter a description of a grade of paper, and a particular type of converting machine (e.g., “1986 Heidelberg Speedmaster 102”) or select a type of converting machine from a pull-down window. In either case, property values for the selected grade of paper determined to run best on the converting machine selected by the purchaser will fill in the spaces in frame 62. A button 66 is also provided for setting a grade of paper and property values to a particular converting machine. This is useful, for example, when a purchaser desires to alter the default values for a converting machine because a particular machine requires paper having values that are different than those prescribed for such machine.

In frame 68, the purchaser may allow the search to extend to paper products having property values that deviate from the values shown in frame 62, but that are within predetermined tolerances. For example, the property “tensile strength” may be specified to have a value of 15 p.s.i. in frame 62 and may be allowed to have a tolerance value of ±2 p.s.i. Tolerances for properties may be set by selecting “Select Tolerances” button 70 to open a window (not shown) allowing the selection of tolerances for property values.

Once the desired paper grade and property values are established, the purchaser automatically submits the query of database information established by papermaking manufacturers by selecting a “Submit” button 72. The databases may be located at each manufacturer's mill, at off-site facilities, or at some other location. Purchasers may download select data from the manufacturers' databases as needed or on a periodic basis if they decide to process the information.

After a search of the data of each manufacturer's database is performed, paper products that are available and have either the exact property values of the desired paper product or property values that fall within predetermined tolerances of the desired paper product (both of which are considered a “match”) are displayed within frame 74 in windows shown at brace 76 as Prod. 1 through Prod. N. Additional information is also provided within frame 74 in windows shown at brace 78 including: whether paper products include property values that “exactly match” or are within tolerance (“w/in tol. match”); total quantity available for purchase (“qty avail”); and either the price per unit quantity of a paper product (“$/qty”) or a prompt to submit a “Bid” for the paper product.

The purchaser may make a selection of a paper product by clicking the selection box below the product at 80. Once a paper product has been selected, the purchaser may either enter a quantity, at which time the total price for the order appears in the “Total” box, and select the “Order” button at frame 82; or enter a quantity, a bid for that quantity, and submit the bid by selecting the “Submit” button at frame 84. An “order” and a “bid” are alternatively referred to herein as an offer to purchase

The paper specification screen 60 is intended to be illustrative of a web site screen through which a purchaser may transmit a desired paper product query including specified property values and receive available product data from database information established by manufacturers. It is anticipated that other screen layouts may be created and found equally useful for specifying grades of paper having one or more particular property values.

An alternate embodiment of the present invention includes functions to automatically monitor and evaluate manufacturing data to determine whether there is a match between desired property values and the actual value for each respective property of a paper product. An alternate embodiment includes functions to monitor and evaluate manufacturing data to determine whether there is stability in a manufacturing process resulting in a high quality paper product. Such higher quality products may automatically trigger a bid for the product.

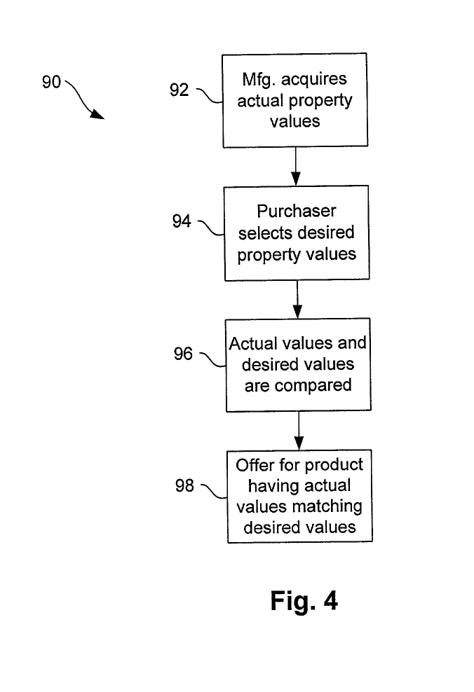

Referring to FIG. 4, a flow chart broadly illustrates a transaction at 90 between a purchaser and a manufacturer pursuant to an embodiment of the present invention. At step 92, the manufacturer acquires manufacturing data during the production of a particular grade of paper. Such manufacturing data includes, for example, actual values for properties of the paper selected from the group including caliper, tensile strength, burst strength, tear resistance, abrasion resistance, picking resistance, fold endurance, ink/water absorptivity, brightness, opacity, finish, softwood/hardwood content, and pH. The data is stored as a database, which is accessible to purchasers. At step 94, the purchaser selects desired values for one or more of the properties of the particular grade of paper. The purchaser may be a buyer for a company that will ultimately use the paper product or an intermediary such as a paper broker.

At step 96, each desired value is compared with the actual value for each respective property of a manufacture of the particular grade of paper to determine whether there is a match between each desired value and the actual value for each respective property. For example, the purchaser may select a desired caliper value for a particular grade of paper. The actual caliper value for a manufacture of the particular grade of paper will be compared to the desired caliper value to determine if they match. As noted above, a match can be either an exact match or one that falls within a predetermined tolerance. With respect to the latter, for example, if the purchaser indicated a desired caliper value and tolerance of 0.0035±0.0003 inch, then an actual caliper value as low as 0.0032 inch and as high as 0.0038 inch are considered a match. Those of ordinary skill in the art will appreciate that the paper manufacturer, purchaser, or a third party such as a distributor of paper products may process the data.

At step 98, if each desired property value and the actual value for each respective property of the particular grade of paper match, then the purchaser may transmit an offer to purchase the particular grade of paper from a paper supplier. The offer to purchase may be an order to purchase the paper product or a bid for the paper product. The paper supplier receiving the offer to purchase may be, for example, the manufacturer of the paper product or a distributor who distributes paper products for the manufacturer.

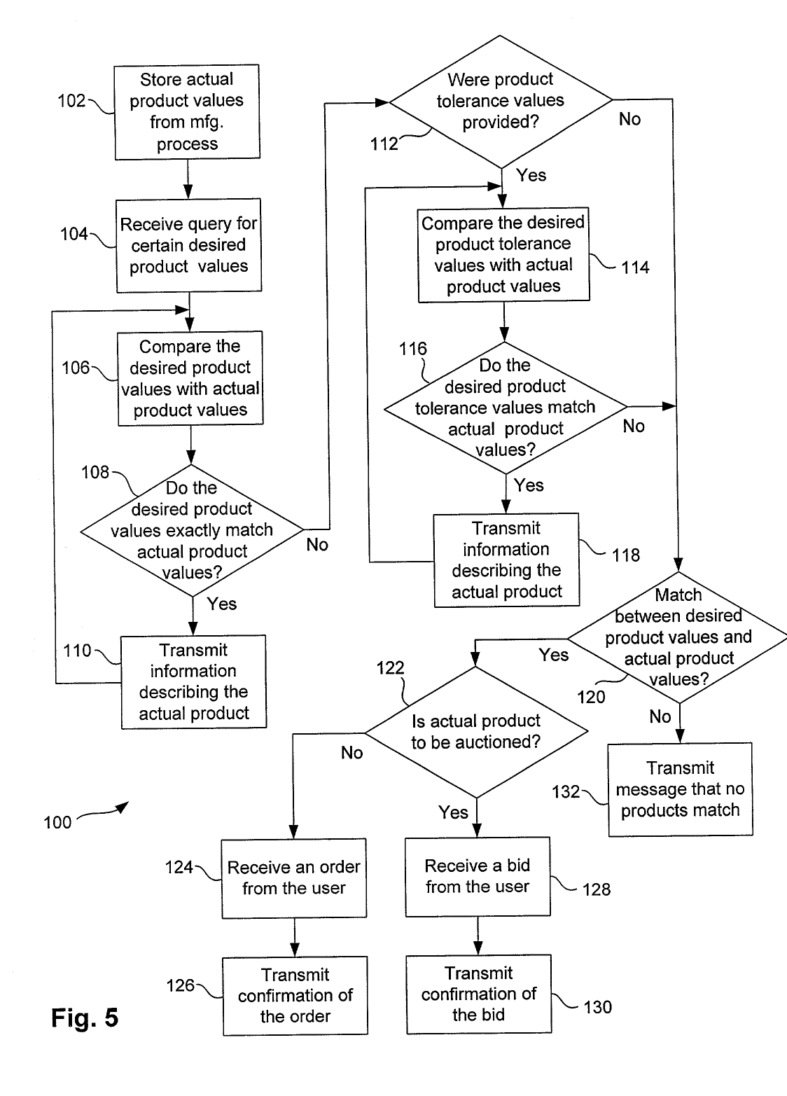

Referring to FIG. 5, a flow chart illustrating the steps of a method of the present invention is shown at 100. At step 102, actual property values for a manufacture of a grade of paper is stored as part of a database. At step 104, a query is received from a purchaser for the paper product, which includes desired values for one or more of the properties of the paper product. At step 106, each desired value is compared with the actual value for each respective property of the paper product to determine if there is a match between each desired value and the actual value for each respective property.

At step 108, if the desired values exactly match the actual product values of the paper product, then the method proceeds to step 110. At step 110, information describing the paper product having matching actual values is transmitted to the purchaser. Thereafter, the method proceeds to step 106 to repeat the comparison step in an effort to determine if there are other paper products of similar grade that have exactly matching actual values.

If, at step 108, the desired values do not exactly match the actual values of a paper product, then the method proceeds to step 112. If, at step 112, it is determined that the purchaser provided tolerances for one or more of the desired values, then the method proceeds to step 114.

At step 114, a comparison is made between the desired tolerance values, i.e., the values falling within the tolerances selected by the purchaser, for each property selected by the purchaser with the actual value for each respective property of the paper product. At step 116, if the desired tolerance values match the actual product values of the paper product (i.e., the actual values fall within tolerance), then the method proceeds to step 118. At step 118, information describing the paper product having matching property values is transmitted to the purchaser. Thereafter, the method proceeds to step 114 to repeat the comparison step in an effort to determine if there are other paper products of similar grade having matching actual values.

If, at step 112, the purchaser did not provide tolerances for one or more of the desired values, then the method proceeds to step 120. If, at step 116, the desired tolerance values do not match the actual values of a paper product, then the method will also proceed to step 120. If, at step 120, there is a match, either exactly or within tolerance, between each desired value and the actual value for each respective property of one or more paper products, then the method proceeds to step 122.

At step 122, if a product is not designated for auction, then, at step 124, an order is received for a product from the purchaser. At step 126, a confirmation of the order is transmitted to the purchaser. Thereafter, the order may be filled, for example, by the manufacturer or a distributor.

If, at step 122, a product is designated for auction, then, at step 128, a bid is received from the purchaser for a paper product. There are a number of on-line systems and methods that may be employed to auction paper products. Examples of such systems and methods from which auction criteria may be obtained are disclosed in U.S. Pat. Nos. 6,026,383; 6,044,363; 6,078,906; 6,161,099; 6,199,050 and 6,202,051, the contents of which are incorporated by reference herein. At step 130, a confirmation of receipt of the bid is transferred to the purchaser. Once the auction is finalized, the results of the auction will be transmitted to all of the purchasers that placed a bid on the auctioned paper product. The winning bidder will transact the final sale of the paper product with, for example, the manufacturer or a distributor.

If, at step 120, there is not a match between the desired property values and the actual property values of a paper product or the desired property tolerance values and the actual property values of the paper product, then the method proceeds to step 132. At step 132, a message is transmitted to the purchaser indicating that there are no paper products that match the query.

It is clear from the foregoing disclosure that the present invention for selecting articles of manufacture provides advancement in the art of selecting and purchasing products. The invention is advantageous to paper manufacturers because, for example, purchasers are less likely to return purchased products since they will more likely purchase a product that fulfills their requirements. Reduced product returns equate to greater profits for paper manufacturers. The invention is advantageous to purchasers because, for example, they are more certain that the paper they purchase will run properly on their converting machines since they are able to select and purchase paper having property specifications known to run well on their converting machines.

It is anticipated that an embodiment of the present invention will include attributes that enable a buyer or purchaser to provide feedback information to a product supplier describing how a particular paper product performed on a particular converting machine. Such feedback information would enable the product supplier to provide improved services. For example, the product supplier may receive the feedback information and correlate a description of the particular paper product with a description of the particular converting machine. Thereafter, when the buyer or purchaser seeks to purchase a paper product for the same converting machine, the product supplier's database may be searched for a paper product having the same or similar properties and the results from the search returned to the buyer or purchaser. An additional advantage is that historical data can then be developed on the particular converting machine enabling an expert system to “learn” about the particular converting machine and provide product suggestions to the buyer or purchaser. Expert systems that may be utilized are known in the art of data processing. For example, U.S. Pat. No. 5,732,397 to De Tore, the contents of which are incorporated by reference herein, discloses an automated system for use in decision-making.

It is further anticipated that the present invention will be beneficial to sellers and purchasers of other manufactured products having measurable properties such as steel products, lubricants, and optical fibers. Furthermore, it is anticipated that the present invention will be beneficial to sellers and purchasers of assembled products such as ball bearings, integrated circuits, and automobiles.

While the invention disclosed herein has been described with respect to various specific embodiments, those skilled in the art will readily appreciate that various modifications, changes, and enhancements may be made thereto without departing from the spirit and scope of the invention as defined by the appended claims.

What is claimed is:

1. A method for selecting an article of manufacture from a plurality of like articles of manufacture over a computer network, the plurality of like articles of manufacture having properties whose actual values are varied due to manufacturing processes, the method comprising:
entering desired values for one or more of the properties of the article of manufacture;
transmitting the desired values to a processor programmed to compare each desired value with the actual value for each respective property of the article of manufacture to determine whether there is a match between each desired value and the actual value for each respective property; and
receiving data from the processor indicating that each desired value is matched by the actual value for each respective property of the article of manufacture.

2. A method as recited in claim 1, wherein the step of entering desired values for one or more of the properties of the article of manufacture includes the step of entering desired values for one or more of the properties of a particular grade of paper, wherein the properties are selected from the group comprising caliper, tensile strength, burst strength, tear resistance, abrasion resistance, picking resistance, fold endurance, ink/water absorptivity, brightness, opacity, finish, softwood/hardwood content, and pH.

3. A method as recited in claim 1, further including the steps of:
entering a description of a converting machine on which the article of manufacture is intended to be used;
receiving default values, associated with the description of the converting machine, for one or more of the properties of the article of manufacture; and
selecting the default values as the desired values for the one or more of the properties of the article of manufacture.

4. A method as recited in claim 3, wherein the step of entering a description of a converting machine includes the step of entering a description of a converting machine selected from the group comprising a printing press, envelope-folding machine, corrugating machine, and a die-cutting machine.

5. A method as recited in claim 1, further including the steps of selecting the article of manufacture and transmitting an offer to purchase the selected article of manufacture to a product supplier.

6. A method as recited in claim 5, wherein the step of transmitting an offer to purchase the selected article of manufacture to a product supplier includes the step of transmitting a bid for the selected article of manufacture to a product supplier.

7. A method as recited in claim 5, wherein the step of transmitting an offer to purchase the selected article of manufacture to a product supplier includes the step of transmitting an order to purchase the selected article of manufacture to a product supplier.

8. A method as recited in claim 1, wherein the step of receiving data from the processor includes the step of receiving data indicating that each desired value is exactly matched by the actual value for each respective property of the article of manufacture.

9. A method as recited in claim 1, further including the step of selecting tolerances for each desired value and transmitting the selected tolerances to the processor, and wherein the step of receiving data from the processor includes the step of receiving data indicating that the actual value for each respective property of the article of manufacture is within the selected tolerances for each desired value.

10. A method for selecting an article of manufacture from a plurality of like articles of manufacture over a computer network, the plurality of like articles of manufacture having properties whose actual values are varied due to manufacturing processes, the method comprising:
acquiring actual values for one or more of the properties of the article of manufacture;
storing the actual values as part of a database;
transmitting the actual values to a processor programmed to compare each desired value of a property selected by a purchaser with the actual value for each respective property of the article of manufacture to determine whether there is a match between each desired value and the actual value for each respective property; and
receiving an offer from the purchaser to purchase the article of manufacture.

11. A method as recited in claim 10, wherein the step of acquiring actual values for one or more of the properties of the article of manufacture includes the step of acquiring actual values for one or more of the properties of a manufacture of a particular grade of paper, wherein the one or more properties are selected from the group comprising caliper, tensile strength, burst strength, tear resistance, abrasion resistance, picking resistance, fold endurance, ink/water absorptivity, brightness, opacity, finish, softwood/hardwood content, and pH.

12. A method as recited in claim 10, wherein the step of transmitting the actual values to a processor includes the step of transmitting the actual values over the computer network to the purchaser for processing.

13. A method as recited in claim 10, wherein the step of transmitting the actual values to a processor includes the step of transmitting the actual values over the computer network to a distributor for processing.

14. A method as recited in claim 10, further including the step of processing the desired values and the actual values with the processor to determine whether there is a match between each desired value and the actual value for each respective property.

15. A method as recited in claim 14, further including the step of transmitting data to the purchaser indicating that each desired value is exactly matched by the actual value for each respective property of the article of manufacture.

16. A method as recited in claim 10, further including the step of receiving offers from additional purchasers to purchase the article of manufacture, wherein the offer received from the purchaser and the offers received from the additional purchasers include bids for the article of manufacture.

17. A method as recited in claim 16, further including the step of determining a winning bid based on predetermined auction criteria.

18. A method as recited in claim 10, wherein the step of receiving an offer from the purchaser includes the step of receiving an order to purchase the article of manufacture.

19. A method as recited in claim 18, further including the step of transmitting data to a distributor to fill the order.

20. A method as recited in claim 10, further including the step of receiving data that describes how the article of manufacture performed when used for a particular application.

21. A method as recited in claim 20, wherein the step of receiving data that describes how the article of manufacture performed when used for a particular application includes the step of receiving data that describes how a manufacture of a particular grade of paper performed when processed on a converting machine and further including the step of correlating the performance data with a description of the converting machine.

22. A computer system for selecting an article of manufacture from a plurality of like articles of manufacture over a computer network, the plurality of like articles of manufacture having properties whose actual values are varied due to manufacturing processes, the computer system comprising:
a memory for storing actual values for properties of the article of manufacture;
a processor in communication with the memory, wherein the processor is operative to
receive the actual values for the properties of the article of manufacture;
store the actual values as part of a database in the memory;
receive a desired value from a purchaser for one or more properties of the article of manufacture;
determine whether there is a match between each desired value and the actual value for each respective property of the article of manufacture by comparing each desired value with the actual value for each respective property;
transmit data to the purchaser indicating that the desired values for the one or more properties are found in the article of manufacture; and
receive an offer from the purchaser to purchase the article of manufacture.

23. A computer system as recited in claim 22, wherein the actual values for the properties of the article of manufacture are measured during the manufacturing processes.

24. A computer system as recited in claim 22, wherein the processor is further operative to receive actual values for properties of a manufacture of a particular grade of paper, wherein the properties are selected from the group comprising caliper, tensile strength, burst strength, tear resistance, abrasion resistance, picking resistance, fold endurance, ink/water absorptivity, brightness, opacity, finish, softwood/hardwood content, and pH.

25. A computer system as recited in claim 22, wherein the processor is further operative to receive offers to purchase the article of manufacture from additional purchasers, wherein the offer received from the purchaser and the offers received from the additional purchasers include bids for the article of manufacture.

26. A computer system as recited in claim 25, wherein the processor is further operative to determine a winning bid based on predetermined auction criteria.

27. A computer system as recited in claim 22, wherein the processor is further operative to transmit data to the purchaser indicating that each desired value is exactly matched by the actual value for each respective property of the article of manufacture.

28. A computer system as recited in claim 22, wherein the processor is further operative to transmit data to the purchaser indicating that the actual value for each respective property of the article of manufacture is within tolerances selected by the purchaser for each desired value.

29. A computer system as recited in claim 22, wherein the offer is an order for the purchase of the article of manufacture and wherein the processor is further operative to transmit the order to a distributor so that the distributor can fill the order.

30. A computer system as recited in claim 22, wherein the processor is further operative to receive data that describes how the article of manufacture performed when used for a particular application.
